(19) United States
(12) Patent Application Publication
(10) Pub. No.: US 2026/0122343 A1
(43) Pub. Date: Apr. 30, 2026

(54) SYSTEMS AND METHODS FOR GUIDED IMAGE CAPTURE

(71) Applicant: Kenvue Brands LLC, Summit, NJ (US)

(72) Inventor: Morteza S. Haeri-Hosseini, Lawrence Township, NJ (US)

(21) Appl. No.: 19/364,628

(22) Filed: Oct. 21, 2025

Related U.S. Application Data
(60) Provisional application No. 63/711,244, filed on Oct. 24, 2024.

(51) Int. Cl. H04N 23/60; H04N 23/56; H04N 23/61; H04N 23/63

(52) U.S. Cl. CPC H04N 23/64; H04N 23/56; H04N 23/61; H04N 23/632

(57) ABSTRACT

Systems and methods for triggering an image to be captured. The method includes detecting that an image capturing device is preparing to capture an image of a subject; obtaining a baseline image of the subject; generating an overlap score between the subject in the baseline image and the subject in a live preview of the image capturing device; generating a positional score between the subject in the baseline image and the subject in the live preview of the image capturing device; generating a light distribution score between the subject in the baseline image and the subject in the live preview of the image capturing device; and, based on the overlap score, the positional score, or the light distribution score being above an overlap threshold, a positional threshold, and a light distribution threshold, respectively, triggering the image to be captured.

### CROSS-REFERENCE TO RELATED APPLICATION

This application claims the benefit of U.S. Provisional Application No. 63/711,244 filed October 24, 2024, the contents of which is incorporated herein by reference in its entirety.

### BACKGROUND

Image capturing is increasingly being performed by a subject, or user, using their own electronic device and in their own space. This may pose challenges when a platform or application attempts to analyze multiple images together, such as comparing changes in the subject over time through the captured images, because in many instances the subject does not take a second image in the same environment, with the same lighting, at the same angle, etc. as a first image. This challenge affects the quality of the analysis of the subject.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various implementations of the present disclosure described herein are directed to systems and methods that guide a subject to an analogous alignment, position, and light distribution as in a baseline image, resulting in improved image analysis. The method includes detecting that an image capturing device is preparing to capture an image of a subject in an environment; obtaining a baseline image of the subject, wherein the baseline image is a previously captured image of the subject in a previous iteration of the environment, and wherein the baseline image includes parameters of the subject in the image to be captured including alignment parameters, positional parameters, and light distribution parameters; generating, by an alignment tool, an overlap score between the subject in the baseline image and the subject in a live preview of the image capturing device; comparing, by the alignment tool, the generated overlap score to an overlap threshold; generating, by a positional controller, a positional score between the subject in the baseline image and the subject in the live preview of the image capturing device; comparing, by the positional controller, the generated positional score to a positional threshold; generating, by a light distributor, a light distribution score between the subject in the baseline image and the subject in the live preview of the image capturing device; comparing, by the light distributor, the generated light distribution score to a light distribution threshold; generating instructions that, when completed, cause at least one of the overlap score, the positional score, or the light distribution score to be increased above the overlap threshold, the positional threshold, or the light distribution threshold, respectively, and presenting, on a user interface, the generated instructions.

In another implementation, a system is provided. The system includes a memory and a processor coupled to the memory. The processor is configured to detect that an image capturing device is preparing to capture an image of a subject in an environment; obtain a baseline image of the subject, wherein the baseline image is a previously captured image of the subject in a previous iteration of the environment, and wherein the baseline image includes parameters of the subject in the image to be captured including alignment parameters, positional parameters, and light distribution parameters; generate, by an alignment tool, an overlap score between the subject in the baseline image and the subject in a live preview of the image capturing device; compare, by the alignment tool, the generated overlap score to an overlap threshold; generate, by a positional controller, a positional score between the subject in the baseline image and the subject in the live preview of the image capturing device; compare, by the positional controller, the generated positional score to a positional threshold; generate, by a light distributor, a light distribution score between the subject in the baseline image and the subject in the live preview of the image capturing device; compare, by the light distributor, the generated light distribution score to a light distribution threshold; generate instructions that, when completed, cause at least one of the overlap score, the positional score, or the light distribution score to be increased above the overlap threshold, the positional threshold, or the light distribution threshold, respectively, and present, on a user interface, the generated instructions.

In another implementation, one or more non-transitory computer readable media storing instructions that, when executed by a processor, cause the processor to detect that an image capturing device is preparing to capture an image of a subject in an environment; obtain a baseline image of the subject, wherein the baseline image is a previously captured image of the subject in a previous iteration of the environment, and wherein the baseline image includes parameters of the subject in the image to be captured including alignment parameters, positional parameters, and light distribution parameters; generate, by an alignment tool, an overlap score between the subject in the baseline image and the subject in a live preview of the image capturing device; compare, by the alignment tool, the generated overlap score to an overlap threshold; generate, by a positional controller, a positional score between the subject in the baseline image and the subject in the live preview of the image capturing device; compare, by the positional controller, the generated positional score to a positional threshold; generate, by a light distributor, a light distribution score between the subject in the baseline image and the subject in the live preview of the image capturing device; compare, by the light distributor, the generated light distribution score to a light distribution threshold; generate instructions that, when completed, cause at least one of the overlap score, the positional score, or the light distribution score to be increased above the overlap threshold, the positional threshold, or the light distribution threshold, respectively, present, on a user interface, the generated instructions; and based on the generated instructions being completed, automatically trigger the image capturing device to capture the image of the subject in the environment.

### BRIEF DESCRIPTION OF THE DRAWINGS

The present description will be better understood from the following detailed description read in light of the accompanying drawings, wherein:

FIG. 1 illustrates an example system for performing a process for guided image capture according to an example;

FIG. 2 illustrates an example computer-implemented method of guiding an image capture process according to an example;

FIG. 3 illustrates an example alignment tool according to an example;

FIG. 4 illustrates an example computer-implemented method of aligning a subject for an image capture process according to an example;

FIGS. 5A-5C illustrates an example user interface presenting and executing an alignment tool according to an example;

FIG. 6 illustrates an example position control tool according to an example;

FIG. 7 illustrates an example computer-implemented method of positioning a subject an optimal distance and orientation from an image capturing device for an image capture process according to an example;

FIG. 8 illustrates an example light distribution tool according to an example;

FIG. 9 illustrates an example computer-implemented method of providing optimal lighting conditions for an image capture process according to an example; and

FIG. 10 is a block diagram illustrating an example computing environment suitable for implementing one or more of the various examples disclosed herein.

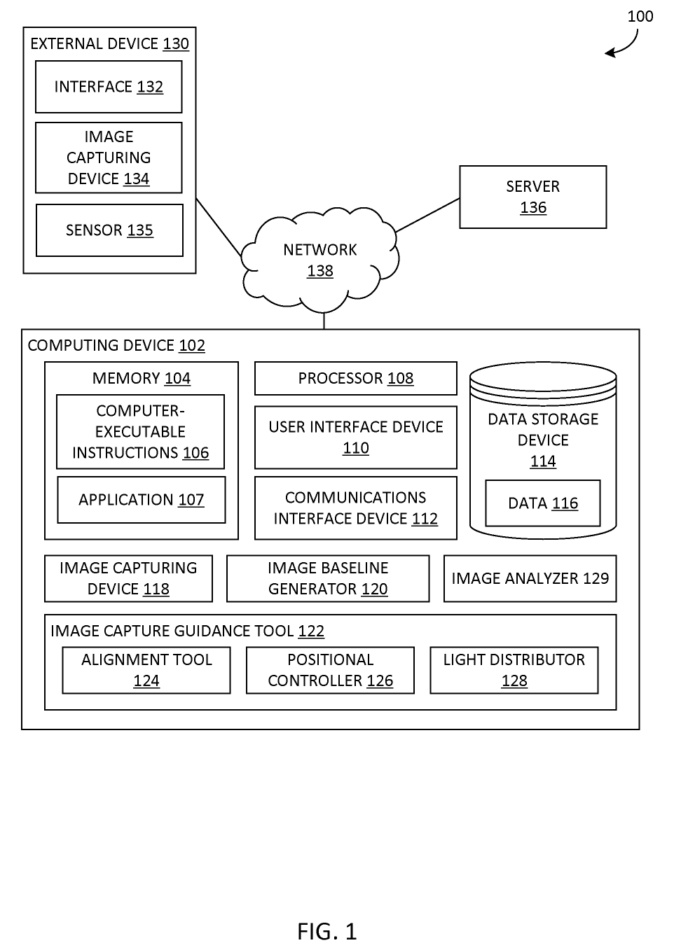

Corresponding reference characters indicate corresponding parts throughout the drawings. In FIGS. 1 to 10, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As described herein, various applications or platforms use remote image capturing and analysis to accurately and reliably monitor changes in a subject’s condition over time. For example, applications in industries such as healthcare and skincare, images may be used to monitor a condition of a subject, such as acne or eczema, by comparing a first image of the subject at a first time, such as before treatment has begun, and then over time at regular intervals to capture the results of a skincare treatment. However, this analysis has inherent risks of errors or inconsistencies in the images themselves that could affect the interpretation of the images. For example, the quality of image analysis may be compromised by differences in the lighting, environment, angle, camera settings, and camera positioning, as well as other environmental factors, in different images of a subject. By standardizing the image capture process, the quality of care and treatment, whether in a healthcare or consumer setting, is improved for patients and consumers.

Various examples of the present disclosure recognize and take into account these challenges and provide systems and methods for a guided image capture on a user device that maintains consistency between captured images at different points in time, such as a previously captured image and a new image being captured. The present disclosure includes a series of harmonized tools that determine a baseline for previously captured images, analyze a field of view of an image capturing device in real time, determine recommended adjustments to one or more features of the field of view, transform the recommended adjustments to one or more digestible visual cues to instruct a subject to adjust the features, and present the visual cues on an interface of the image capturing device.

The systems and methods for performing guided image capture operate in an unconventional manner by standardizing the image capture process across different time points in order to improve the consistency between captured images, which may then be used to remotely monitor and treat a skincare condition in a patient. The present disclosure standardizes the image capture process through an alignment tool, a positional controller, and a light distribution tool that each generate separate recommendations for capturing an image of a subject that will result in a high degree of similarity with a baseline image. The alignment, or overlay, tool provides, on the interface, a baseline image of a subject and a live preview of the subject, each of which is semi-transparent, in order to assist the user in capturing the subject at the same alignment, angle, and distance from the image capture device as the baseline image. The alignment tool identifies features on the baseline image, identifying analogous features on the live preview of the field of view of the image capturing device, and then generates, in real time, an overlap score between the baseline image and live preview image based on an intersection over union (IOU) between the identified features in the baseline image and live preview. In some examples, the alignment tool causes the image to be automatically captured upon the overlap score being greater than or equal to a threshold overlap value. The positional controller obtains a mesh of the subject in the baseline image, generates a mesh of the subject in live preview, and analyzes the obtained mesh and the generated mesh to determine whether or not the features in the identified subject appear in the same size and proportion as the analogous features of the subject in the baseline image. The light distribution tool detects shadows on the subject, ambient lighting, and so forth and compares the lighting values to the shadows and ambient lighting in the baseline image and generates visual cues that are provided on the interface to guide the subject to make changes in their environment that will improve the image similarity.

Accordingly, the systems and methods provides a technical solution to the inherently technical problem of providing reliable and accurate remote monitoring of changes in a subject’s skincare condition and treatments over time due to inconsistencies in images captured that illustrate a state of the skincare condition at a particular time. The technical solution includes a system that implements multiple artificial intelligence (AI) or machine learning (ML) algorithms to determine a baseline of a subject based on a previously captured image and, based on the determined baseline, perform separate analyses of a live preview of a field of view of an image capturing device.

As referenced herein, an image capturing device may be a standalone camera, a camera implemented on an electronic device, a video capturing device, or any other suitable device capable of capturing an image. The image capturing device analyzes a previously captured image of a subject and compares the previously captured image to a live preview of a field of view of an image capturing device. The previously captured image is an image of a subject, such as a user. The image of the subject may include a particular feature of the subject, such as a face, an arm, a leg, or any other part of the body of the subject upon which a skincare condition may be monitored. The previously captured image is selected, either manually by the subject or automatically based on the subject being detected in the live preview of the field of view of the image capturing device.

FIG. 1 illustrates an example system for performing a process for guided image capture according to an example. The system 100 illustrated in FIG. 1 is provided for illustration only. Other examples of the system 100 may be used without departing from the scope of the present disclosure.

The system 100 includes a computing device 102, an external device 130, a server 136, and a network 138. The computing device 102 represents any device executing computer-executable instructions 106 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 may also include less-portable devices such as servers, desktop personal computers, kiosks, or tabletop devices. Additionally, the computing device 102 may represent a group of processing units or other computing devices.

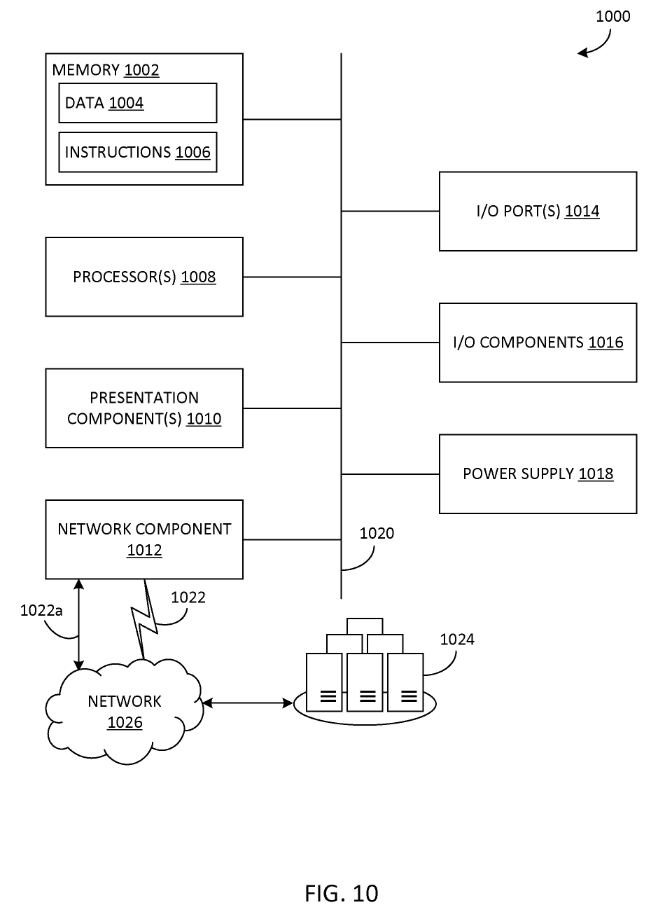

In some examples, the computing device 102 includes at least one processor 108, a memory 104 that includes the computer-executable instructions 106, and a user interface device 110. The processor 108 includes any quantity of processing units and is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIG. 10. In various examples, the processor 108 is configured to execute computer-executable instructions of one or more of an image capturing device 118, an image baseline generator 120, an image capture guidance tool 122, and an image analyzer 129.

The memory 104 includes any quantity of media associated with or accessible by the computing device 102. In some examples, the memory 104 is internal to the computing device 102. In other examples, the memory 104 is external to the computing device 102 or both internal and external to the computing device 102. For example, the memory 104 may include both a memory component internal to the computing device 102 and a memory component external to the computing device 102, such as the server 152. The memory 104 stores data, such as one or more applications 107. The applications 107, when executed by the processor 108, operate to perform various functions on the computing device 102. The applications 107 may communicate with counterpart applications or services, such as web services accessible via the network 138. In an example, the applications 107 represent server-side services of an application executing in a cloud, such as a cloud server 136. In some examples, the application 107 is an application for performing guided image capture as described herein.

The user interface device 110 includes a graphics card for displaying data to a user and receiving data from the user. The user interface device 110 may also include computer-executable instructions, for example a driver, for operating the graphics card. Further, the user interface device 110 may include a display, for example a touch screen display or natural user interface, and/or computer-executable instructions, for example a driver, for operating the display. The user interface device 110 may also include one or more of the following to provide data to the user or receive data from the user: speakers, a sound card, a camera, a microphone, a vibration motor, one or more accelerometers, a BLUETOOTH® communication module, global positioning system (GPS) hardware, and a photoreceptive light sensor. In a non-limiting example, the user inputs commands or manipulates data by moving the computing device 102 in one or more ways.

The computing device 102 further includes a communications interface device 112. The communications interface device 112 includes a network interface card and/or computer-executable instructions, such as a driver, for operating the network interface card. Communication between the computing device 102 and other devices, such as but not limited to the external device 130 or the server 136, may occur using any protocol or mechanism over any wired or wireless connection.

The computing device 102 further includes a data storage device 114 for storing data 116. The data 116 includes, but is not limited to, previously captured images, historical baseline image data including feature information, centroid information, positional information, light information, and so forth for one or more baseline images, data associated with historical trends for a subject over time, a threshold overlap value for use by an alignment tool 124, and any other suitable data used by the system 100.

The image capturing device 118 is a device implemented on the computing device 102 that captures video or images. In some examples, the image capturing device 118 is a camera, a video recorder, or any other suitable device to capture video or images. In some examples, the image capturing device 118 is controlled manually by a user of the computing device 102 to capture an image or video. In other examples, the image capturing device 118 is controlled by the image capture guidance tool 122 to automatically capture an image based on one or more conditions being met, as described in greater detail herein.

The image baseline generator 120 is an example of a specialized processing unit implemented on the processor 108 that generates baseline data for a previously captured image or images, i.e., a baseline image, that, in turn, is used as a baseline when capturing an additional image. In some examples, the baseline image is a previously captured image of the subject in a previous iteration of the environment. The image baseline generator 120 generates baseline data that include baseline alignment data, baseline positional data, and baseline light distribution data. Baseline alignment data includes data from the baseline image that includes, but is not limited to, subject data, feature data, centroid data associated with the feature data, distance data between various centroids, and so forth. Baseline positional data includes data from the baseline image that includes, but is not limited to, distance data measuring a distance from the subject to an image capturing device used to capture the image, orientation data of the subject relative to the image capturing device used to capture the image, and so forth. Baseline light distribution data includes data from the baseline image that includes, but is not limited to, detected shadows in the baseline image, intensity of light in the baseline image, a location and position of a light source in the baseline image, and so forth. The generated baseline image, and associated baseline data, is stored in the data storage device 114 as examples of the data 116. In some examples, the image baseline generator 120 generates a mesh of the subject including the identified features. For example, the image baseline generator 120 may implement one or more tools to scan and process the baseline image and, based on the processing, generate a mesh to segment identified features on the subject. The segmentation is then used to generate spatial cues and/or tags used for calculating an overlap score between the baseline image and a new image to be captured.

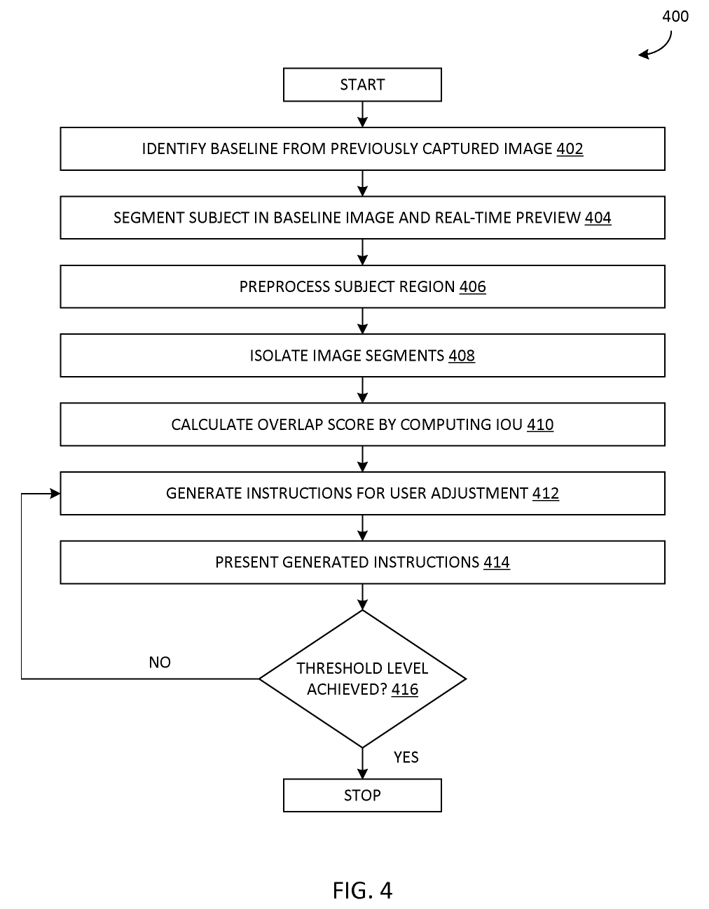

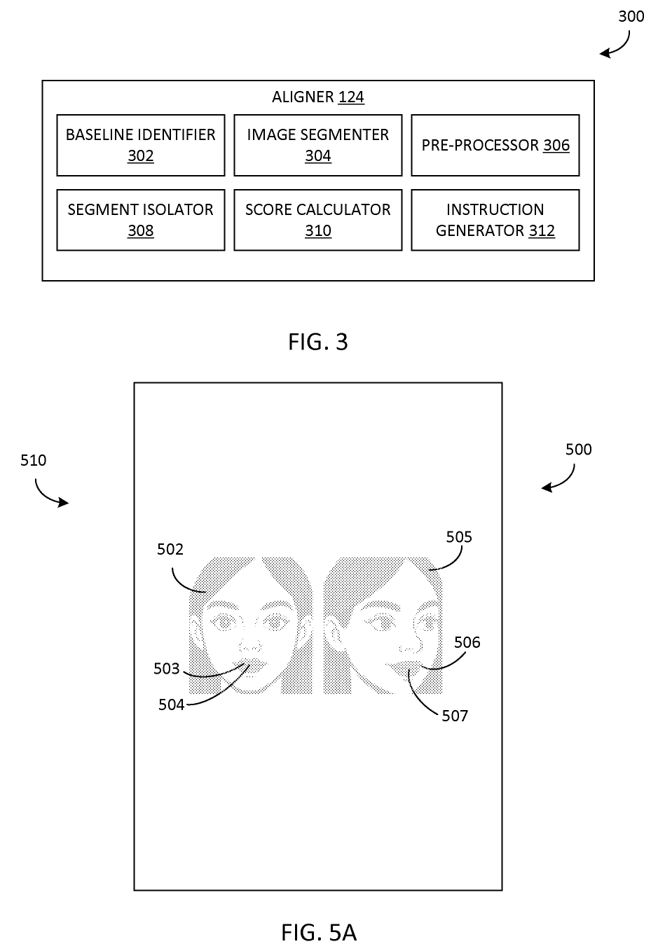

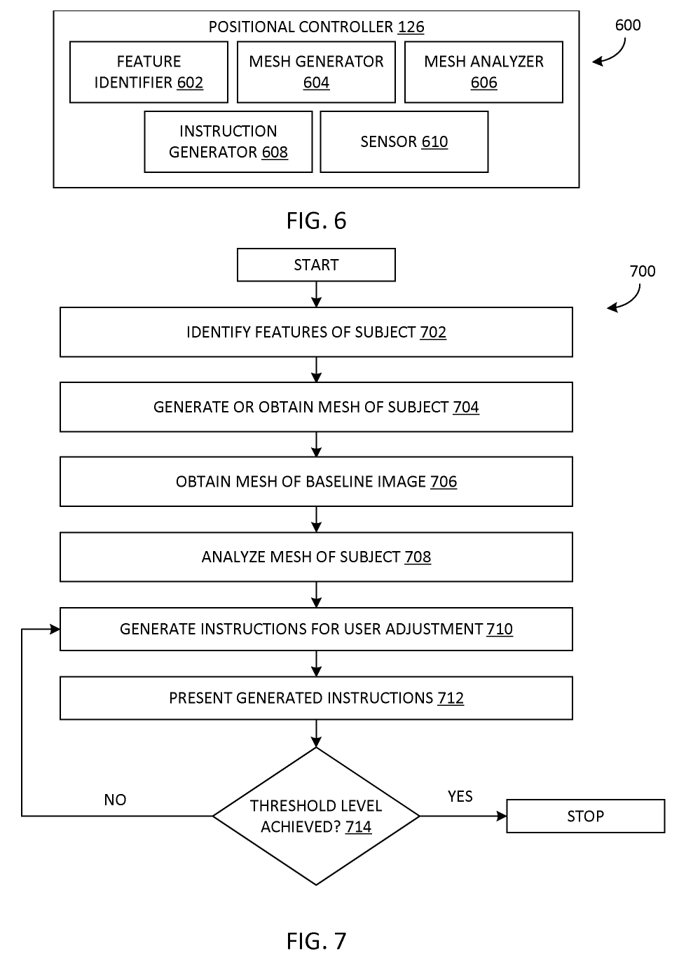

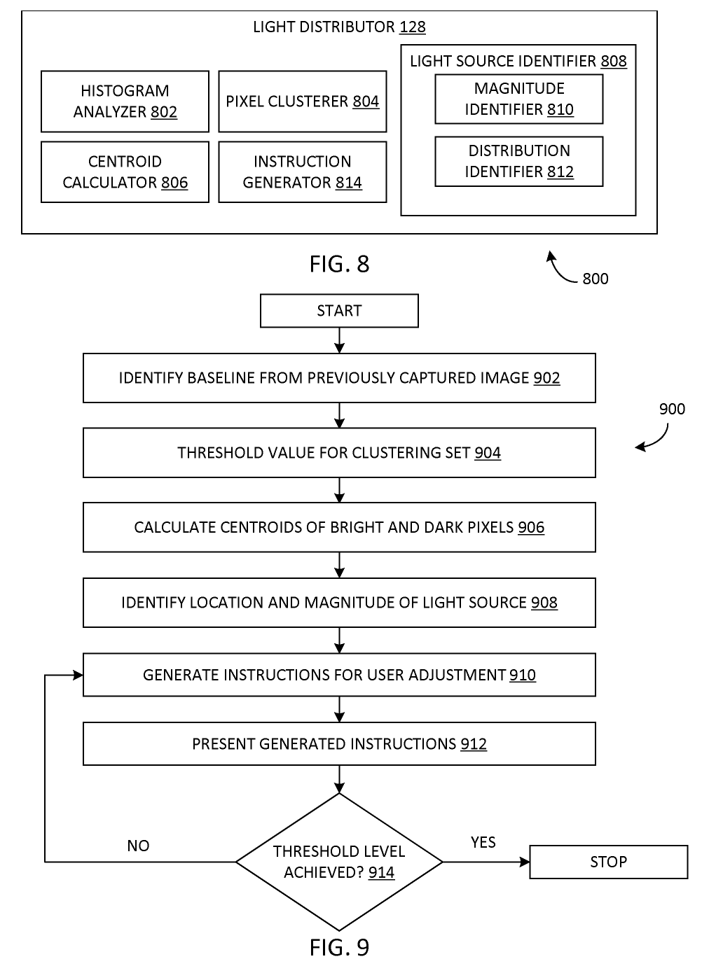

The image capture guidance tool 122 is an example of a specialized processing unit implemented on the processor 108 that guides the process of image capture. In some examples, the image capture guidance tool 122 is implemented on the same device as the image capturing device 118, such as the computing device 102. In other examples, the image capture guidance tool 122 is implemented on a separate device than the image capturing device, for example where the image capturing device 134 is implemented on an external device 130. The image capture guidance tool 122 includes an alignment tool, 124, a positional controller 126, and a light distributor 128. Each of the alignment tool 124, the positional controller 126, and the light distributor 128 are additional examples of specialized processing units implemented on the processor 108. The alignment tool 124 is described in further detail below with regards to FIGS. 3 and 4. The positional controller 126 is described in further detail below with regards to FIGS. 6 and 7. The light distributor 128 is described in further detail below with regards to FIGS. 8 and 9.

The image analyzer 129 is an example of a specialized processing unit implemented on the processor 108 that analyzes a captured image, such as an image captured by the image capturing device 118 or 134. The image analyzer 129 may be implemented on the computing device 102, as shown, or on an external device, such as the external device 130. The image analyzer 129 may be included as an aspect of an application, such as the application 107, that performs, in whole or in part, image analysis. For example, the image analyzer 129 may be included in a skincare analysis application that analyzes skincare, such as acne or other skin blemishes, and recommends one or more skincare products, regimens, or a combination of these.

The external device 130 is another example of a computing device, separate from and external of the computing device 102. In some examples, the external device 130 includes a mobile computing device or any other portable device. A mobile computing device includes, for example but without limitation, a mobile telephone, laptop, tablet, computing pad, netbook, gaming device, and/or portable media player. The external device 130 may also include less-portable devices such as servers, desktop personal computers, kiosks, or tabletop devices. Additionally, the external device 130 may represent a group of processing units or other computing devices. The server 136, in some examples, is an example of an external storage device, remote data storage device, a data storage in a remote data center, or a cloud storage. The external device 130 and/or the server 136 communicate with the computing device 102 via the network 138.

In some examples, the external device 130 includes an interface 132 and an image capturing device 134. In some examples, the interface 132 is an example of a graphical user interface (GUI). The interface 132 may be used to illustrate a live preview of a field of view of the image capturing device 134, including instructions or recommendations generated by the image capture guidance tool 122 in order to capture an image of a subject using the external device 130. For example, the interface 132 may illustrate a semi-transparent baseline image of the subject and a semi-transparent live preview of the subject in order to assist the user in capturing the subject at the same alignment, angle, and distance from the image capture device as the baseline image. The interface 132 may further present visual cues from one or both of the positional controller 126 and the light distributor 128 to guide the subject to make changes in their environment that will improve the image similarity to the baseline image.

The image capturing device 134 is a device implemented on the external device 130 that captures video or images. In some examples, the image capturing device 134 is a camera, a video recorder, or any other suitable device to capture video or images. In some examples, the image capturing device 134 is controlled manually by a user of the external device 130 to capture an image or video. In other examples, the image capturing device 134 is controlled by the image capture guidance tool 122 through signals transmitted via the network 138 to automatically capture an image based on one or more conditions being met, as described in greater detail herein.

In some examples, the external device 130 includes a sensor 135. The sensor 135 may include an accelerometer or another on-device sensor that detects or identifies a particular angle of the of the external device 130 as the external device 130 is used to capture the image.

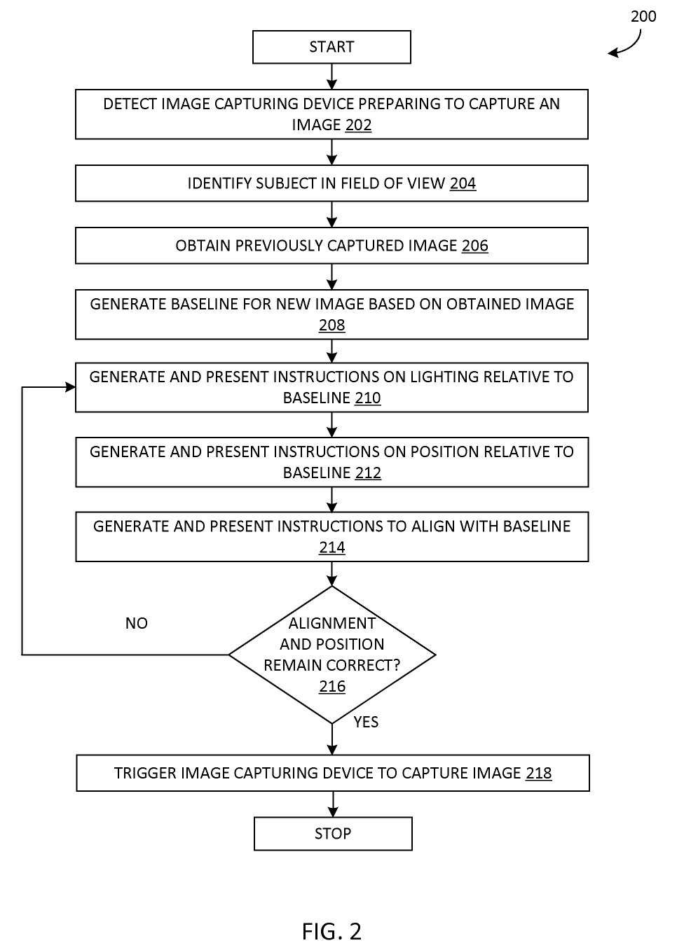

FIG. 2 illustrates an example computer-implemented method of guiding an image capture process according to an example. The computer-implemented method 200 is presented for illustration only and should not be construed as limiting. Other examples of the computer-implemented method 200 may be used without departing from the scope of the present disclosure. In some examples, the computer-implemented method 200 is implemented by one or more electronic devices described herein, such as the computing device 102, and in particular the image baseline generator 120 and the image capture guidance tool 122.

The method 200 begins by the image capture guidance tool 122 detecting that an image capturing device is preparing to capture an image in operation 202. As described herein, the image capturing device may be the image capturing device 118 or the image capturing device 134. In some examples, the image capture guidance tool 122 detects the image capturing device 118 or 134 is preparing to capture an image by receiving an indication from the image capturing device 118 or 134. In other examples, the image capture guidance tool 122 detects the image capturing device 118 or 134 is preparing to capture an image by receiving an indication from the user interface device 110 or interface 132, respectively.

In operation 204, the image baseline generator 120 identifies a subject in a field of view in a live preview of the image capturing device 118 or 134. In some examples, the subject corresponds to a user of an application 107, such as a skin monitoring application. The image baseline generator 120 may pull data 116, such as a user profile that is logged into the application 107, from the data storage device 114 to identify the user of the application 107 and analyzes the live preview to identify an area of the body included in the live preview, such as an arm, a face, a foot, and so forth. Thus, the image baseline generator 120 identifies who the user is and the subject of the image to be captured.

In operation 206, the image baseline generator 120 obtains a previously captured image of the subject. For example, where the image baseline generator 120 determines the subject is a face of a user, the image baseline generator 120 obtains the most recently captured image of the user’s face from the data storage device 114 or a remote storage location, such as the server 136. In some examples, all previous images taken of a particular user are stored, timestamped, and tagged with a particular subject area, such as face, arm, and so forth. In this example, the most recent image of the identified subject area is obtained. In other examples, only a most recent image of a particular subject area is stored and tagged with a particular subject area, and all previous iterations are deleted from storage. In this example, the only stored image is obtained. In yet other examples, no images are retained and only metadata and image information is retained, such as the information used to generate the baseline for a next image.

In operation 208, the image baseline generator 120 generates a baseline for a new image to be captured based on the obtained previously captured image. The image baseline generator 120 generates a baseline for each of alignment, position, and light distribution that are used by the alignment tool 124, positional controller 126, and light distributor 128, respectively, to guide the image capture process. As described herein, the image baseline generator 120 generates baseline data that include baseline alignment data, baseline positional data, and baseline light distribution data based on the previously captured image. Baseline alignment data includes data from the baseline image that includes, but is not limited to, subject data, feature data, centroid data associated with the feature data, distance data between various centroids, and so forth. Baseline positional data includes data from the baseline image that includes, but is not limited to, distance data measuring a distance from the subject to an image capturing device used to capture the image, orientation data of the subject relative to the image capturing device used to capture the image, and so forth. Baseline light distribution data includes data from the baseline image that includes, but is not limited to, detected shadows in the baseline image, intensity of light in the baseline image, a location and position of a light source in the baseline image, and so forth.

As described herein, generating baseline data based on the previously captured image, rather than an abstractly ideal baseline data, provides two distinct functionalities. First, this provides for increased consistency between a previous image and a newly captured image. While current solutions may provide for an ideal scenario for each instance of image capture, this may result in first and second images that are dissimilar to each other, causing the second image to be ineffective for future image analysis. In contrast, the present application enables optimal image analysis to be performed based on the initial captured image being used as the baseline, regardless of whether the initial captured image itself was captured based on optimal conditions. Second, the present application enables the implementation of thresholds that control for image quality of the second image. As the initial captured image was deemed sufficient, such baseline data is used to also ensure baseline quality of the additional image to be captured.

In operation 210, based on the image capture guidance tool 122 determining the subject is within the field of view of the live preview, the image capture guidance tool 122 generates instructions that, when followed, presents the subject in the live preview in substantially similar light distribution as the lighting in the baseline image. Accordingly, the baseline data for the previously captured image is to be used for the next captured image. For example, the light distributor 128 assesses the overall lighting intensity histogram of the baseline image and sets a threshold value to cluster pixels into bright and dark groups. Centroids of the bright and dark pixels are calculated and used as the basis to identify the location of a light source of the live preview, as well as to generate and present visual cues as to how the subject is to turn and/or move, or adjust lighting in their environment, to provide optimal lighting conditions for capturing an image of the subject in the live preview. For example, in an ideally spatially uniformly illuminated image, the centroid of the dark and bright pixels overlap in the center of the image.

In operation 212, the image capture guidance tool 122 generates instructions that, when followed, positions the subject in the same orientation as and at the same distance away from the image capturing device 118 or 134 as the baseline image. For example, the positional controller 126 obtains a mesh of the subject in the baseline image, generates a mesh of the subject in live preview, and analyzes the obtained mesh and the generated mesh to determine whether or not the features in the identified subject appear in the same size and proportion as the analogous features of the subject in the baseline image. The positional controller 126 generates and presents instructions that, when followed, position the subject in the same orientation as and at the same distance away from the image capturing device 118 or 134 as the baseline image.

In operation 214, the image capture guidance tool 122 generates instructions that, when followed, align the subject with the generated baseline image and presents the instructions on the user interface device 110 or interface 132. The instructions are generated by the alignment tool 124 as described in greater detail with regards to FIGS. 3 and 4. For example, the alignment tool 124 segments the subject in each of the baseline image and the live preview, pre-processes the region by resizing and denoising the image in the live preview, breaks down each image into boxes, and computes the intersection over union (IOU) to calculate an overlap, or alignment, score to identify how closely the subject in the live preview overlaps, or aligns, with the baseline image. The instructions are generated and presented on the user interface device 110 or interface 132 in real time so that as the subject moves in the live preview to align with the baseline image based on the instructions, the overlap score is updated. The alignment tool 124 continues to generate updated instructions for the subject to adjust the alignment until the overlap score is greater than a threshold overlap score.

In some examples, each of the instructions presented in operations 210-214 are generated and presented as text instructions. For example, the text instructions may be presented as “Please move your head to the left” or “Please move your arm further away from the camera.” In other examples, the instructions are generated and translated so that they are presented as an illustration. For example, the instructions may include a semi-transparent version of the baseline image along the live preview so that the subject may be adjusted to come into alignment with the baseline image.

In operation 216, the image capture guidance tool 122 determines whether, following the alignment being corrected in the live preview, whether the lighting and position of the subject remain correct. Adjustments to one of the lighting, position, and alignment can affect one of the other elements. For example, the adjustment(s) to the lighting may cause changes to alignment and/or the position of the subject within the live preview. The alignment tool 124 recomputes the overlap score and the positional controller 126 recalculates the position of the subject. Where the alignment and/or the position of the subject are no longer correct, the image capture guidance tool 122 returns to operation 210 and regenerates instructions for alignment of the subject with the baseline image. Where the alignment and position of the subject remain correct, the method proceeds to operation 218.

It should be understood that although illustrated herein as a series of steps, this example should not be construed as limiting. Various examples are possible. For example, each of operations 210-214 may be performed simultaneously and instructions for each of alignment, position, and light distribution may be displayed as a single set of instructions, such as “Please move the subject to the left, turn the subject to the right, and turn lights on more brightly.” In other examples, operations 210-214 may be performed in a different order than as illustrated in FIG. 2.

In operation 218, the image capture guidance tool 122 triggers the image capturing device 118 or 134 to capture an image based on the image capture guidance tool 122 determining the alignment and position of the subject remain correct while the subject aligns with the baseline of the preview image. In some examples, the image capture guidance tool 122 transmits a signal to the image capturing device 118 or 134 to capture the image of the subject. The signal is transmitted as a response to various conditions being present and met, such as the overall overlap score, alignment, position, lighting, or any combination of these.

FIG. 3 illustrates an example alignment tool according to an example. The example alignment tool, or alignment tool 124, illustrated in FIG. 3 is provided for illustration only. Other examples of the alignment tool 124 may be used without departing from the scope of the present disclosure.

As illustrated in FIG. 3, the alignment tool 124 includes a baseline identifier 302, an image segmenter 304, a pre-processor 306, a segment isolator 308, a score calculator 310, and an instruction generator 312. Each of the baseline identifier 302, image segmenter 304, pre-processor 306, segment isolator 308, score calculator 310, and instruction generator 312 are examples of specialized processing units implemented on the alignment tool 124 that execute instructions, such as the computer-executable instructions 106 or other computer-executable instructions, such as those that may be stored on the external device 130 or the server 136.

FIG. 4 illustrates an example computer-implemented method of aligning a subject for an image capture process according to an example. The example computer-implemented method 400 is presented for illustration only and should not be construed as limiting. Other examples of the computer-implemented method 400 may be used without departing from the scope of the present disclosure. In some examples, the computer-implemented method 400 is implemented by one or more electronic devices described herein, such as the computing device 102 and/or the external device 130.

The computer-implemented method 400 begins by the baseline identifier 302 identifying a baseline image in operation 402. The identified baseline image is used for analysis of a subject identified in a live preview of a field of view of the image capturing device 118 or 134. The baseline identifier 302 identifies the baseline for the subject that is generated by the image baseline generator 120. For example, as described herein, the image baseline generator 120 determines the subject in a live preview, obtains a recently captured image of the subject, and generates the baseline for the new image to be captured. The baseline identifier 302 obtains, or identifies, the subject in the live preview and obtains the baseline for the new image to be captured.

In operation 404, the image segmenter 304 segments the subject in each of the baseline image and the live preview. For example, the image segmenter 304 isolates the subject in the baseline image from the subject in the live preview. In some examples, the image segmenter 304 controls the user interface device 110 or interface 132 to provide the isolated subject at a transparency that is less than 100%, such as 50%, in order for the subject in the baseline image to be overlaid on the subject in the live preview.

In operation 406, the pre-processor 306 pre-processes the image of the subject for analysis. In some examples, the pre-processing includes resizing and denoising the subject in the live preview. For example, the pre-processor 306 identifies a size of the subject in the live preview and changes the size of the baseline image to correspond to the size of the subject in the live preview. Further, the pre-processor 306 identifies and removes noise, i.e., background images or other features found in the live preview, from the live preview so that a user capturing the image may more easily align the subject in the live preview from the subject in the baseline image. For example, the pre-processor 306 may remove the noise from the live preview or may add a blurring effect to features determined to be noise in the live preview.

In operation 408, the segment isolator 308 isolates the segments of the image of the subject in the live preview and the subject in the baseline image. In some examples, the segment isolator 308 further isolates the images based on features identified in the subject. For example, where the subject is a face, various facial features such as ears, eyes, mouth, nose, eyebrows, chin, and so forth are isolated. In other examples, the subjects are further isolated based on size of the segments, so that each segment of the subject is roughly the same size. It should be understood that the segment isolator 308 performs the isolation on each of the image in the live preview as well as the baseline image, and the same type of isolation is performed on each image. In other words, where the segment isolator 308 isolates segments of the image in the live preview based on facial features, the segment isolator 308 also isolates segments of the baseline image based on facial features.

In operation 410, the score calculator 310 calculates an overlap score between the image in the live preview and the baseline image by computing an intersection over union (IOU) value between the image in the live preview and the baseline image. In some examples, the score calculator 310 executes one or more algorithms to calculate a distance between centroids of the features identified and isolated in the baseline image and centroids of the analogous features identified and isolated in the image in the live preview, and then executes a summation function that calculates an overall overlap score based on all of the calculated distances.

In some examples, the operations 404-408 performed by the image segmenter 304, pre-processor 306, and segment isolator 308 generate a mesh of the subject in the live preview, while the score calculator 310 calculates the overlap score in operation 410 based on computing the IOU values of the generated mesh of the subject in the live preview and the generated mesh of the baseline image.

In operation 412, the instruction generator 312 generates instructions that, when presented on the user interface device 110 or the interface 132, instruct a user to adjust in a manner that will increase the calculated overlap score. In some examples, the generated instructions include text of the instructions. For example, the text instructions may be presented as “Please move your head to the left” or “Please move your arm further away from the camera.” In some examples, the generated instructions include visual cues instructing a way in which the subject may align with the image in the baseline preview, such as arrows that point to a direction in which the subject should move.

In operation 414, the generated instructions are presented on an interface. In examples where the live preview is presented on the user interface device 118 and the image is to be captured by the image capturing device 118, the generated instructions are presented on the user interface device 118. In examples where the live preview is presented on the interface 132 and the image is to be captured by the image capturing device 134, the generated instructions are presented on the interface 132.

In operation 416, based on an adjustment being made to the live preview, such as the subject moving or otherwise changing its position or the computing device 102 or external device 130 being moved or adjusted, the score calculator 310 calculates an updated overlap score and determines whether a threshold level of overlap has been achieved. In some examples, the score calculator 310 calculates the updated overlap score and compares the updated overlap score to a threshold overlap level. Where the threshold level of overlap has not been achieved, the computer-implemented method 400 returns to operation 412 and generates additional instructions for an additional adjustment. Where the threshold level of overlap has been achieved, the computer-implemented method 400 terminates, as the image is either captured or additional analysis, such as by one or both of the positional controller 126 or the light distributor 128 is performed.

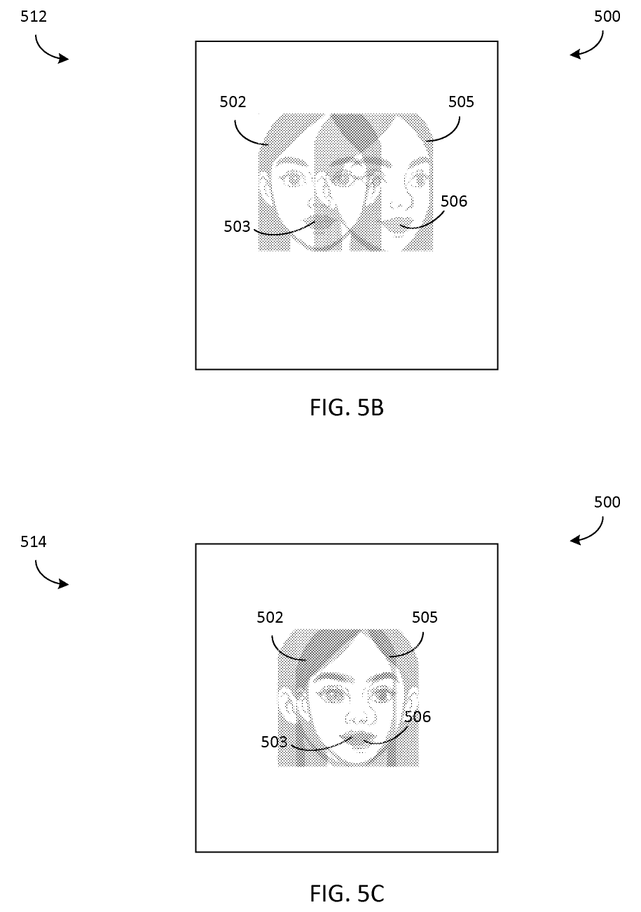

FIGS. 5A-5C illustrates an example user interface presenting and executing an alignment tool according to an example. The user interface 500 illustrated in FIGS. 5A-5C is presented for illustration only. Other examples of the user interface 500 may be used without departing from the scope of the present disclosure.

In some examples, the user interface 500 is an example of the user interface device 110. In other examples, the user interface 500 is an example of the interface 132. The user interface 500 includes a baseline image 502 and a live preview image 505. The baseline image 502 is an example of the baseline image generated in operation 208. The baseline image 502 includes one or more features 503, such as eyes, a nose, a mouth, ears, and so forth. It should be understood that although illustrated in FIGS. 5A-5C as a face, the baseline image 502 is not limited to a face or facial features and may be an image of any part of a subject. For example, the baseline image 502 may be an image of an arm, a leg, a torso, a foot, a hand, or any other part of the body. Each of the features 503 includes a centroid 504, which is the center of the feature 503.

The live preview image 505 is an example of the subject in the field of view of a live preview of an image capturing device 118 or the image capturing device 134 that is presented on either the user interface device 110 or the interface 132, respectively. The live preview image 505 is analogous to the baseline image 502, i.e., is an image of the same subject as the baseline image 502, as the baseline image 502 is selected and obtained based on the live preview image 505. Accordingly, the live preview image 505 includes one or more features 506, such as eyes, a nose, a mouth, ears, and so forth, analogous to the features 503. It should be understood that although illustrated in FIGS. 5A-5C as a face, the live preview image 505 is not limited to a face or facial features and may be an image of any part of a subject. For example, the live preview image 505 may be an image of an arm, a leg, a torso, a foot, a hand, or any other part of the body. Each of the features 506 includes a centroid 507, which is the center of the feature 506.

FIG. 5A illustrates a first position 510 of the live preview image 505 relative to the baseline image 502. As shown in FIG. 5A, the live preview image 505 partially, but not fully, overlaps with the baseline image 502. Based on the partial overlap between the live preview image 505 and the baseline image 502, the score calculator 310 calculates an overlap score between the live preview image 505 and the baseline image 502 based on feature mapping and analysis of the distances between the centroids 504 and 507 of the features 503 and 506, respectively. For example, the first overlap score may be 0.2, as there is little overlap in the first position 510 between the live preview image 505 and the baseline image 502.

FIG. 5B illustrates a second position 512 of the live preview image 505 relative to the baseline image 502. In some examples, the live preview image 505 may move to the second position 512 relative to the baseline image 502 as a result of following and generated instructions that, when followed by the subject, increase the overlap score. A second overlap score generated when the live preview image 505 is in the second position 512 is greater than the first overlap score when the live preview image 505 is in the first position 510. For example, where the first overlap score is 0.2, the second overlap score may be 0.5.

FIG. 5C illustrates a third position 514 of the live preview image 505 relative to the baseline image 502. In some examples, the live preview image 505 may move to the third position 514 relative to the baseline image 502 as a result of following and generated instructions that, when followed by the subject, increase the overlap score. A third overlap score generated when the live preview image 505 is in the third position 514 is greater than the second overlap score when the live preview image 505 is in the second position 512. For example, where the second overlap score is 0.5, the third overlap score may be 0.9. As described herein, the third overlap score may be greater than or equal to an overlap threshold, causing the image capturing device 118 or 134 to automatically capture the live preview image 505.

In some examples, the feature mapping includes an image comparison and an image overlay. The image comparison is an example of a comparison between two images, such as a first image and a second image, such as a baseline image and a live preview image. The image comparison identifies the same features, or centroids of the same features, and maps the features to one another. The image overlay overlays the first image and the second image based on centroids, where each centroid in the second image is overlaid on the corresponding centroid in the first image. In some examples, the image comparison analyzes the centroids identified in the generated mesh of the baseline image by the image baseline generator 120 and the generated mesh of the subject in the live preview by the alignment tool 124 and/or the positional controller 126 to compare the two images.

In some examples, the feature mapping includes additional controls for the pose, angle, and distance of an object. Controls for object pose include correcting for changes in the vertical and/or horizontal angles of the object from the baseline image to the live preview image. For example, as illustrated in FIGS. 6 and 7, the positional controller adjusts for distance and orientation differences between the two images, including vertical and/or horizontal angles of a particular object in order to capture high-fidelity image to image alignment.

FIG. 6 illustrates an example position control tool according to an example. The example positional controller 126 illustrated in FIG. 6 is provided for illustration only. Other examples of the positional controller 126 may be used without departing from the scope of the present disclosure.

As illustrated in FIG. 6, the positional controller 126 includes a feature identifier 602, a mesh generator 604, a mesh analyzer 606, an instruction generator 608, and a sensor 610. Each of the feature identifier 602, mesh generator 604, mesh analyzer 606, instruction generator 608, and sensor 610 are examples of specialized processing units implemented on the positional controller 126 that execute instructions, such as the computer-executable instructions 106 or other computer-executable instructions, such as those that may be stored on the external device 130 or the server 136.

FIG. 7 illustrates an example computer-implemented method of positioning a subject an optimal distance and orientation from an image capturing device for an image capture process according to an example. The example computer-implemented method 700 is presented for illustration only and should not be construed as limiting. Other examples of the computer-implemented method 700 may be used without departing from the scope of the present disclosure. In some examples, the computer-implemented method 700 is implemented by one or more electronic devices described herein, such as the computing device 102 and/or the external device 130.

The computer-implemented method 700 begins by the feature identifier 602 identifying features of a subject in a live preview of the image capturing device 118 or 134 in operation 702. As referenced herein, the subject may be an arm, a face, a foot, and so forth.

In operation 704, the mesh generator 604 generates or obtains a mesh of the identified subject. For example, the mesh generator 604 may implement one or more tools, such as the sensor 610, to scan and process the live preview image and, based on the processing, generate a mesh to segment identified features on the subject. The sensor 610 may include an accelerometer or another on-device sensor that detects or identifies a particular angle of the of the device being used to capture the image, such as the computing device 102 or the external device 130 as the sensor 135. In another example, the mesh generator 604 may obtain an already generated mesh of the identified subject, such as where a mesh has already been generated by the alignment tool 124 as described herein.

In operation 706, the mesh analyzer 606 obtains a mesh of the baseline image corresponding to the identified subject. For example, as described herein, the image baseline generator 120 obtains a mesh of the subject, including the identified features, in the obtained baseline image. The obtained mesh is stored, such as in the data storage device 114 or the server 136 as data 116. The obtained mesh is then obtained from the data storage device 114. In some examples, the obtained mesh includes the mesh of the subject at a particular angle, as identified by the sensor 610.

In operation 708, the mesh analyzer 606 analyzes the generated mesh of the identified subject and the obtained mesh of the baseline image. For example, the mesh analyzer 606 analyzes the generated mesh of the identified subject to determine whether or not the features in the identified subject appear in the same size and proportion as the analogous features of the subject in the baseline image. Where the subject in the live preview is in the same orientation, for example as determined by the sensor 610, and distance relative to the image capturing device 118 or 134 as the subject in the baseline image, the subject is determined to be positioned at an orientation and distance at which an accurate analysis of the captured image can be made relative to the baseline image. However, where the subject in the live preview is not in either the same orientation or distance, or both, relative to the image capturing device 118 or 134 as the subject in the baseline image, the subject is determined to not be positioned at an orientation and distance at which an accurate analysis of the captured image can be made relative to the baseline image, and therefore the orientation or distance of the subject relative to the image capturing device 118 or 134 is to be adjusted.

In various examples, the mesh analyzer 606 may determine the subject is not positioned at an orientation and distance analogous to that of the baseline image. In some examples, the mesh analyzer 606 may generate an overlap score between the subject in the live preview image and the baseline image, similar to the overlap score generated by the alignment tool 124 and described herein. In other examples, the mesh analyzer 606 may compare the size and amount visible of each feature identified on the subject to those on the baseline image. For example, where the subject is closer to the image capturing device 118 or 134 than in the baseline image, the features will appear larger than in the baseline image, and where the subject is further away from the capturing device 118 or 134 than in the baseline image, the features will appear smaller than in the baseline image. Similarly, if the subject is positioned at a different orientation than in the baseline image, more of some features will appear than in the baseline image while less of other features will appear than in the baseline image.

In operation 710, the instruction generator 608 generates instructions that, when presented on the user interface device 110 or the interface 132, instruct a user to adjust in a manner that will increase the calculated overlap score. In some examples, the generated instructions include text of the instructions. For example, the text instructions may be presented as “Please move closer to the camera” or “Please rotate your arm away from the camera.” In some examples, the generated instructions include visual cues instructing a way in which the subject may align with the image in the baseline preview, such as arrows that point to a direction in which the subject should move.

In operation 712, the generated instructions are presented on an interface. In examples where the live preview is presented on the user interface device 118 and the image is to be captured by the image capturing device 118, the generated instructions are presented on the user interface device 118. In examples where the live preview is presented on the interface 132 and the image is to be captured by the image capturing device 134, the generated instructions are presented on the interface 132.

In operation 714, based on an adjustment being made to the live preview, such as the subject moving or otherwise changing its position or the computing device 102 or external device 130 being moved or adjusted, the mesh analyzer 606 calculates an updated overlap score and determines whether a threshold level of overlap has been achieved. In some examples, the mesh analyzer 606 calculates the updated overlap score and compares the updated overlap score to a threshold overlap level. Where the threshold level of overlap has not been achieved, the computer-implemented method 700 returns to operation 710 and generates additional instructions for an additional adjustment. Where the threshold level of overlap has been achieved, the computer-implemented method 700 terminates.

FIG. 8 illustrates an example light distribution tool according to an example. The example light distributor 128 illustrated in FIG. 8 is provided for illustration only. Other examples of the light distributor 128 may be used without departing from the scope of the present disclosure.

As illustrated in FIG. 8, the light distributor 128 includes a histogram analyzer 802, a pixel clusterer 804, a centroid calculator 806, a light source identifier 808, and an instruction generator 814. The light source identifier 808 further includes a magnitude identifier 810 and a distribution identifier 812. Each of the histogram analyzer 802, pixel clusterer 804, centroid calculator 806, light source identifier 808, and instruction generator 814 are examples of specialized processing units implemented on the light distributor 128 that execute instructions, such as the computer-executable instructions 106 or other computer-executable instructions, such as those that may be stored on the external device 130 or the server 136.

FIG. 9 illustrates an example computer-implemented method of providing optimal lighting conditions for an image capture process according to an example. The example computer-implemented method 900 is presented for illustration only and should not be construed as limiting. Other examples of the computer-implemented method 900 may be used without departing from the scope of the present disclosure. In some examples, the computer-implemented method 900 is implemented by one or more electronic devices described herein, such as the computing device 102 and/or the external device 130.

The computer-implemented method 900 begins by the histogram analyzer 802 identifying a baseline light distribution from an overall lighting intensity histogram in operation 902. For example, the histogram analyzer 802 obtains the baseline image from the data storage device 114 or the server 136, obtains or generates an overall lighting intensity histogram of the baseline image, and based on the histogram, determines a baseline for lighting, including magnitude and distribution, of a new image to be captured.

In operation 904, the pixel clusterer 804 sets a threshold value for clustering of image pixels. The pixel clusterer 804 clusters the image pixels into one or more bright groups and one or more dark groups. In operation 906, the centroid calculator 806 calculates the centroids of each group. For example, a centroid is calculated for each bright group and a centroid is calculated for each dark group.

In operation 908, the light source identifier 808 identifies the location and magnitude of the light source of the image in the live preview of the image capturing device 118 or 134. The light source identifier 808 includes the magnitude identifier 810 to identify the magnitude of the light source and the distribution identifier 812 to identify the distribution of the light source. In some examples, a single light source is identified. In other examples, multiple light sources are identified, such as two lamps, an overhead light and a lamp, and so forth. In these examples, the magnitude and distribution of each light source is identified.

In operation 910, the instruction generator 814 generates instructions that, when presented on the user interface device 110 or the interface 132, instruct a user to adjust the light source or for the user to adjust relative to the light source to align the centroid of the bright group with the centroid of the baseline image and the centroid of the dark group with the centroid of the baseline image such that the magnitude and distribution of each light source is aligned with that of the baseline image above the degree of the light distribution threshold. In some examples, the generated instructions include text of the instructions. For example, the text instructions may be presented as “Please move closer to the camera” or “Please rotate your arm away from the camera.” In some examples, the generated instructions include visual cues instructing a way in which the lighting of the subject may align with the lighting of the subject in the baseline preview, such as arrows that point to a direction in which the subject should move.

In operation 912, the generated instructions are presented on an interface. In examples where the live preview is presented on the user interface device 118 and the image is to be captured by the image capturing device 118, the generated instructions are presented on the user interface device 118. In examples where the live preview is presented on the interface 132 and the image is to be captured by the image capturing device 134, the generated instructions are presented on the interface 132.

In operation 914, based on an adjustment being made to the live preview, such as the subject changing its position or the light source being adjusted, the histogram analyzer 802 determines whether a threshold level of light distribution is similar between the baseline image and the image in the live preview. Where the threshold level has not been achieved, the computer-implemented method 900 returns to operation 910 and generates additional instructions for an additional adjustment. Where the threshold level has been achieved, the computer-implemented method 900 terminates.

### Example Operating Environment

FIG. 10 is a block diagram of an example computing device 1000 for implementing aspects disclosed herein and is designated generally as computing device 1000. Computing device 1000 is an example of a suitable computing environment and is not intended to suggest any limitation as to the scope of use or functionality of the examples disclosed herein. Neither should computing device 1000 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1000 includes a bus 1020 that directly or indirectly couples the following devices: computer-storage memory 1002, one or more processors 1008, one or more presentation components 1010, I/O ports 1014, I/O components 1016, a power supply 1018, and a network component 1012. While computing device 1000 is depicted as a seemingly single device, multiple computing devices 1000 may work together and share the depicted device resources. For example, memory 1002 may be distributed across multiple devices, and processor(s) 1008 may be housed with different devices.

Bus 1020 represents what may be one or more busses (such as an address bus, data bus, or a combination thereof). Although the various blocks of FIG. 10 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 10 and the references herein to a “computing device.” Memory 1002 may take the form of the computer-storage media references below and operatively provide storage of computer-readable instructions, data structures, program modules and other data for computing device 1000. In some examples, memory 1002 stores one or more of an operating system, a universal application platform, or other program modules and program data. Memory 1002 is thus able to store and access data 1004 and instructions 1006 that are executable by processor 1008 and configured to carry out the various operations disclosed herein.

In some examples, memory 1002 includes computer-storage media in the form of volatile and/or nonvolatile memory, removable or non-removable memory, data disks in virtual environments, or a combination thereof. Memory 1002 may include any quantity of memory associated with or accessible by computing device 1000. Memory 1002 may be internal to computing device 1000 (as shown in FIG. 10), external to computing device 1000, or both. Examples of memory 1002 include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 1000. Additionally, or alternatively, memory 1002 may be distributed across multiple computing devices 1000, for example, in a virtualized environment in which instruction processing is carried out on multiple computing devices 1000. For the purposes of this disclosure, “computer storage media,” “computer-storage memory,” “memory,” and “memory devices” are synonymous terms for computer-storage memory 1002, and none of these terms include carrier waves or propagating signaling.

Processor(s) 1008 may include any quantity of processing units that read data from various entities, such as memory 1002 or I/O components 1016 and may include CPUs and/or GPUs. Specifically, processor(s) 1008 are programmed to execute computer-executable instructions for implementing aspects of the disclosure. The instructions may be performed by the processor, by multiple processors within computing device 1000, or by a processor external to client computing device 1000. In some examples, processor(s) 1008 are programmed to execute instructions such as those illustrated in the in the accompanying drawings. Moreover, in some examples, processor(s) 1008 represent an implementation of analog techniques to perform the operations described herein. For example, the operations may be performed by an analog client computing device 1000 and/or a digital client computing device 1000. Presentation component(s) 1010 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1000, across a wired connection, or in other ways. I/O ports 1014 allow computing device 1000 to be logically coupled to other devices including I/O components 1016, some of which may be built in. Example I/O components 1016 include, for example but without limitation, a microphone, joystick, game pad, satellite dish, scanner, printer, wireless device, etc.

Computing device 1000 may operate in a networked environment via network component 1012 using logical connections to one or more remote computers. In some examples, network component 1012 includes a network interface card and/or computer-executable instructions (e.g., a driver) for operating the network interface card. Communication between computing device 1000 and other devices may occur using any protocol or mechanism over any wired or wireless connection. In some examples, network component 1012 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1012 communicates over wireless communication link 1022 and/or a wired communication link 1022a to a cloud resource 1024 across network 1026. Various different examples of communication links 1022 and 1022a include a wireless connection, a wired connection, and/or a dedicated link, and in some examples, at least a portion is routed through the internet.

Although described in connection with an example computing device 1000, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and are non-transitory, i.e., exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

In some examples, a computer-implemented method includes detecting that an image capturing device is preparing to capture an image of a subject in an environment; obtaining a baseline image of the subject, wherein the baseline image is a previously captured image of the subject in a previous iteration of the environment, and wherein the baseline image includes parameters of the subject in the image to be captured including alignment parameters, positional parameters, and light distribution parameters; generating, by an alignment tool, an overlap score between the subject in the baseline image and the subject in a live preview of the image capturing device; comparing, by the alignment tool, the generated overlap score to an overlap threshold; generating, by a positional controller, a positional score between the subject in the baseline image and the subject in the live preview of the image capturing device; comparing, by the positional controller, the generated positional score to a positional threshold; generating, by a light distributor, a light distribution score between the subject in the baseline image and the subject in the live preview of the image capturing device; comparing, by the light distributor, the generated light distribution score to a light distribution threshold; generating instructions that, when completed, cause at least one of the overlap score, the positional score, or the light distribution score to be increased above the overlap threshold, the positional threshold, or the light distribution threshold, respectively, and presenting, on a user interface, the generated instructions.

In some examples, a system includes a memory and a processor coupled to the memory. The processor is configured to detect that an image capturing device is preparing to capture an image of a subject in an environment; obtain a baseline image of the subject, wherein the baseline image is a previously captured image of the subject in a previous iteration of the environment, and wherein the baseline image includes parameters of the subject in the image to be captured including alignment parameters, positional parameters, and light distribution parameters; generate, by an alignment tool, an overlap score between the subject in the baseline image and the subject in a live preview of the image capturing device; compare, by the alignment tool, the generated overlap score to an overlap threshold; generate, by a positional controller, a positional score between the subject in the baseline image and the subject in the live preview of the image capturing device; compare, by the positional controller, the generated positional score to a positional threshold; generate, by a light distributor, a light distribution score between the subject in the baseline image and the subject in the live preview of the image capturing device; compare, by the light distributor, the generated light distribution score to a light distribution threshold; generate instructions that, when completed, cause at least one of the overlap score, the positional score, or the light distribution score to be increased above the overlap threshold, the positional threshold, or the light distribution threshold, respectively, and present, on a user interface, the generated instructions.

In some examples, one or more non-transitory computer readable media storing instructions that, when executed by a processor, cause the processor to detect that an image capturing device is preparing to capture an image of a subject in an environment; obtain a baseline image of the subject, wherein the baseline image is a previously captured image of the subject in a previous iteration of the environment, and wherein the baseline image includes parameters of the subject in the image to be captured including alignment parameters, positional parameters, and light distribution parameters; generate, by an alignment tool, an overlap score between the subject in the baseline image and the subject in a live preview of the image capturing device; compare, by the alignment tool, the generated overlap score to an overlap threshold; generate, by a positional controller, a positional score between the subject in the baseline image and the subject in the live preview of the image capturing device; compare, by the positional controller, the generated positional score to a positional threshold; generate, by a light distributor, a light distribution score between the subject in the baseline image and the subject in the live preview of the image capturing device; compare, by the light distributor, the generated light distribution score to a light distribution threshold; generate instructions that, when completed, cause at least one of the overlap score, the positional score, or the light distribution score to be increased above the overlap threshold, the positional threshold, or the light distribution threshold, respectively, present, on a user interface, the generated instructions; and based on the generated instructions being completed, automatically trigger the image capturing device to capture the image of the subject in the environment.

Further examples are described herein.

Various examples further include one or more of the following:

based on determining that each of the generated overlap score is greater than the overlap threshold, the generated positional score is greater than the positional threshold, and the generated light distribution score is greater than the light distribution threshold, automatically causing the image capturing device to capture the image of the subject in the environment;

wherein generating the overlap score between the subject in the baseline image and the subject in the live preview of the image capturing device further comprises: segmenting the subject in each of the baseline image and the live preview of the image capturing device; pre-processing the segmented subject; isolating the pre-processed segmented subject, wherein the isolating includes identifying a feature in each of the baseline image and the subject in the live preview of the image capturing device; and calculating an intersection over union (IOU) value for the identified feature of the baseline image and the subject in the live preview of the image capturing device, wherein the IOU value is the overlap score;

wherein the baseline image is a previously captured image of the subject in a previous iteration of the environment, and wherein the baseline image includes parameters of the subject in the image to be captured including alignment parameters, positional parameters, and light distribution parameters;

determining the subject in the environment has followed the generated instructions; and based on the determination the subject in the environment has followed the generated instructions, perform a second determination as to whether each of the overlap score, the positional score, and the light distribution score are above the overlap threshold, the positional threshold, or the light distribution threshold, respectively;

based on determining that at least one of the overlap score, the positional score, and the light distribution score are not above the overlap threshold, the positional threshold, or the light distribution threshold, respectively, generating additional instructions that, when completed, cause at least one of the overlap score, the positional score, or the light distribution score to be increased above the overlap threshold, the positional threshold, or the light distribution threshold, respectively;

based on determining that each of the overlap score, the positional score, and the light distribution score are above the overlap threshold, the positional threshold, and the light distribution threshold, respectively, triggering the image capture device to capture the image of the subject in the environment;

obtaining the baseline image of the subject further comprises obtaining a mesh of the baseline image, the obtained mesh including first features;

generating the instructions that, when completed, cause the overlap score to be increased above the overlap threshold further comprises: generating a second mesh of the subject in the environment, the generated second mesh including second features; analyzing the generated second mesh of the subject in the environment; and generating instructions that, when completed, cause the second features to align with the first features, wherein the alignment of the second features to the first features cause the overlap score to be increased above the overlap threshold;

identifying the image of the subject in the environment in the live preview of the image capturing device; and

wherein generating the light distribution score further comprises: identifying a baseline light distribution for the image of the subject in the environment, the identified baseline light distribution having baseline centroids; setting a threshold value for clustering of image pixels in the live preview; clustering the image pixels into a first group of pixels and a second group of pixels; calculating a first centroid for the first group of pixels and a second centroid for the second group of pixels; identifying a location and a magnitude of a light source in the live preview; and generating instructions that, when completed, cause the baseline centroids to align with the calculated first centroid and the calculated second centroid.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computer-implemented method, comprising:
detecting that an image capturing device is preparing to capture an image of a subject in an environment;
obtaining a baseline image of the subject;
generating, by an alignment tool, an overlap score between the subject in the baseline image and the subject in a live preview of the image capturing device;
comparing, by the alignment tool, the generated overlap score to an overlap threshold;
generating, by a positional controller, a positional score between the subject in the baseline image and the subject in the live preview of the image capturing device;
comparing, by the positional controller, the generated positional score to a positional threshold;
generating, by a light distributor, a light distribution score between the subject in the baseline image and the subject in the live preview of the image capturing device;
comparing, by the light distributor, the generated light distribution score to a light distribution threshold;
generating instructions that, when completed, cause at least one of the overlap score, the positional score, or the light distribution score to be increased above the overlap threshold, the positional threshold, or the light distribution threshold, respectively, and
presenting, on a user interface, the generated instructions.

2. The computer-implemented method of claim 1, further comprising:
based on determining that each of the generated overlap score is greater than the overlap threshold, the generated positional score is greater than the positional threshold, and the generated light distribution score is greater than the light distribution threshold, automatically causing the image capturing device to capture the image of the subject in the environment.

3. The computer-implemented method of claim 1, wherein generating the overlap score between the subject in the baseline image and the subject in the live preview of the image capturing device further comprises:
segmenting the subject in each of the baseline image and the live preview of the image capturing device;
pre-processing the segmented subject;
isolating the pre-processed segmented subject, wherein the isolating includes identifying a feature in each of the baseline image and the subject in the live preview of the image capturing device; and
calculating an intersection over union (IOU) value for the identified feature of the baseline image and the subject in the live preview of the image capturing device, wherein the IOU value is the overlap score.

4. The computer-implemented method of claim 1, wherein the baseline image is a previously captured image of the subject in a previous iteration of the environment, and wherein the baseline image includes parameters of the subject in the image to be captured including alignment parameters, positional parameters, and light distribution parameters.

5. The computer-implemented method of claim 1, further comprising:
determining the subject in the environment has followed the generated instructions; and
based on the determination the subject in the environment has followed the generated instructions, perform a second determination as to whether each of the overlap score, the positional score, and the light distribution score are above the overlap threshold, the positional threshold, or the light distribution threshold, respectively.

6. The computer-implemented method of claim 5, further comprising:
based on determining that at least one of the overlap score, the positional score, and the light distribution score are not above the overlap threshold, the positional threshold, or the light distribution threshold, respectively, generating additional instructions that, when completed, cause at least one of the overlap score, the positional score, or the light distribution score to be increased above the overlap threshold, the positional threshold, or the light distribution threshold, respectively.

7. The computer-implemented method of claim 5, further comprising:
based on determining that each of the overlap score, the positional score, and the light distribution score are above the overlap threshold, the positional threshold, and the light distribution threshold, respectively, triggering the image capture device to capture the image of the subject in the environment.

8. The computer-implemented method of claim 1, wherein:
obtaining the baseline image of the subject further comprises obtaining a mesh of the baseline image, the obtained mesh including first features; and
generating the instructions that, when completed, cause the overlap score to be increased above the overlap threshold further comprises:
generating a second mesh of the subject in the environment, the generated second mesh including second features;
analyzing the generated second mesh of the subject in the environment; and
generating instructions that, when completed, cause the second features to align with the first features, wherein the alignment of the second features to the first features cause the overlap score to be increased above the overlap threshold.

9. The computer-implemented method of claim 1, further comprising:
identifying the image of the subject in the environment in the live preview of the image capturing device.

10. The computer-implemented method of claim 9, wherein generating the light distribution score further comprises:
identifying a baseline light distribution for the image of the subject in the environment, the identified baseline light distribution having baseline centroids;
setting a threshold value for clustering of image pixels in the live preview;
clustering the image pixels into a first group of pixels and a second group of pixels;
calculating a first centroid for the first group of pixels and a second centroid for the second group of pixels;
identifying a location and a magnitude of a light source in the live preview; and
generating instructions that, when completed, cause the baseline centroids to align with the calculated first centroid and the calculated second centroid.

11. A system, comprising:
a memory; and
a processor coupled to the processor and configured to:
detect that an image capturing device is preparing to capture an image of a subject in an environment;
obtain a baseline image of the subject, wherein the baseline image is a previously captured image of the subject in a previous iteration of the environment, and wherein the baseline image includes parameters of the subject in the image to be captured including alignment parameters, positional parameters, and light distribution parameters;
generate, by an alignment tool, an overlap score between the subject in the baseline image and the subject in a live preview of the image capturing device;
compare, by the alignment tool, the generated overlap score to an overlap threshold;
generate, by a positional controller, a positional score between the subject in the baseline image and the subject in the live preview of the image capturing device;
compare, by the positional controller, the generated positional score to a positional threshold;
generate, by a light distributor, a light distribution score between the subject in the baseline image and the subject in the live preview of the image capturing device;
compare, by the light distributor, the generated light distribution score to a light distribution threshold;
generate instructions that, when completed, cause at least one of the overlap score, the positional score, or the light distribution score to be increased above the overlap threshold, the positional threshold, or the light distribution threshold, respectively, and
present, on a user interface, the generated instructions.

12. The system of claim 11, wherein the processor is further configured to, based on determining that each of the generated overlap score is greater than the overlap threshold, the generated positional score is greater than the positional threshold, and the generated light distribution score is greater than the light distribution threshold, automatically cause the image capturing device to capture the image of the subject in the environment.

13. The system of claim 11, wherein, to generate the overlap score between the subject in the baseline image and the subject in the live preview of the image capturing device, the processor is further configured to:
segment the subject in each of the baseline image and the live preview of the image capturing device;
pre-process the segmented subject;
isolate the pre-processed segmented subject, wherein the isolating includes identifying a feature in each of the baseline image and the subject in the live preview of the image capturing device; and
calculate an intersection over union (IOU) value for the identified feature of the baseline image and the subject in the live preview of the image capturing device, wherein the IOU value is the overlap score.

14. The system of claim 11, wherein the processor is further configured to:
determine the subject in the environment has followed the generated instructions; and
based on the determination the subject in the environment has followed the generated instructions, perform a second determination as to whether each of the overlap score, the positional score, and the light distribution score are above the overlap threshold, the positional threshold, or the light distribution threshold, respectively.

15. The system of claim 14, wherein the processor is further configured to:
based on determining that at least one of the overlap score, the positional score, and the light distribution score are not above the overlap threshold, the positional threshold, or the light distribution threshold, respectively, generate additional instructions that, when completed, cause at least one of the overlap score, the positional score, or the light distribution score to be increased above the overlap threshold, the positional threshold, or the light distribution threshold, respectively; and
based on determining that each of the overlap score, the positional score, and the light distribution score are above the overlap threshold, the positional threshold, and the light distribution threshold, respectively, trigger the image capture device to capture the image of the subject in the environment.

16. The system of claim 11, wherein:
the processor is further configured to obtain the baseline image of the subject further comprises obtaining a mesh of the baseline image, the obtained mesh including first features; and
to generate the instructions that, when completed, cause the overlap score to be increased above the overlap threshold, the processor is further configured to:
generate a second mesh of the subject in the environment, the generated second mesh including second features;
analyze the generated second mesh of the subject in the environment; and
generate instructions that, when completed, cause the second features to align with the first features, wherein the alignment of the second features to the first features cause the overlap score to be increased above the overlap threshold.

17. The system of claim 11, wherein:
the processor is further configured to identify the image of the subject in the environment in the live preview of the image capturing device; and
to generate the light distribution score, the processor is further configured to:
identify a baseline light distribution for the image of the subject in the environment, the identified baseline light distribution having baseline centroids;
set a threshold value for clustering of image pixels in the live preview;
cluster the image pixels into a first group of pixels and a second group of pixels;
calculate a first centroid for the first group of pixels and a second centroid for the second group of pixels;
identify a location and a magnitude of a light source in the live preview; and
generate additional instructions that, when completed, cause the baseline centroids to align with the calculated first centroid and the calculated second centroid.

18. One or more non-transitory computer readable media storing instructions that, when executed by a processor, cause the processor to:
detect that an image capturing device is preparing to capture an image of a subject in an environment;
obtain a baseline image of the subject, wherein the baseline image is a previously captured image of the subject in a previous iteration of the environment, and wherein the baseline image includes parameters of the subject in the image to be captured including alignment parameters, positional parameters, and light distribution parameters;
generate, by an alignment tool, an overlap score between the subject in the baseline image and the subject in a live preview of the image capturing device;
compare, by the alignment tool, the generated overlap score to an overlap threshold;
generate, by a positional controller, a positional score between the subject in the baseline image and the subject in the live preview of the image capturing device;
compare, by the positional controller, the generated positional score to a positional threshold;
generate, by a light distributor, a light distribution score between the subject in the baseline image and the subject in the live preview of the image capturing device;
compare, by the light distributor, the generated light distribution score to a light distribution threshold;
generate instructions that, when completed, cause at least one of the overlap score, the positional score, or the light distribution score to be increased above the overlap threshold, the positional threshold, or the light distribution threshold, respectively,
present, on a user interface, the generated instructions; and
based on the generated instructions being completed, automatically trigger the image capturing device to capture the image of the subject in the environment.

19. The one or more non-transitory computer readable media of claim 18, further storing instructions that, when executed by the processor, cause the processor to:
based on determining that each of the generated overlap score is greater than the overlap threshold, the generated positional score is greater than the positional threshold, and the generated light distribution score is greater than the light distribution threshold, automatically causing the image capturing device to capture the image of the subject in the environment.

20. The one or more non-transitory computer readable media of claim 18, further storing instructions for generating the overlap score between the subject in the baseline image and the subject in the live preview of the image capturing device that, when executed by the processor, cause the processor to:
segment the subject in each of the baseline image and the live preview of the image capturing device;
pre-process the segmented subject;
isolate the pre-processed segmented subject, wherein the isolating includes identifying a feature in each of the baseline image and the subject in the live preview of the image capturing device; and
calculate an intersection over union (IOU) value for the identified feature of the baseline image and the subject in the live preview of the image capturing device, wherein the IOU value is the overlap score.
